(19) United States
(12) Patent Application Publication
(10) Pub. No.: US 2024/0029177 A1
(43) Pub. Date: Jan. 25, 2024

(54) FACTORY SIMULATOR-BASED SCHEDULING SYSTEM USING REINFORCEMENT LEARNING

(71) Applicant: Neurocore Co., Ltd., Seoul (KR)

(72) Inventors: Young Min YUN, Seoul (KR); Ho Yeoul LEE, Seoul (KR)

(21) Appl. No.: 18/031,285

(22) PCT Filed: Sep. 7, 2021
(86) PCT No.: PCT/KR2021/012157

§ 371 Date: Apr. 11, 2023

(30) Foreign Application Priority Data
Oct. 20, 2020 (KR) 10-2020-0136206

(51) Int. Cl. G06Q 50/04; G06N 3/092; G06Q 10/067; G06Q 10/0633

(52) U.S. Cl. CPC G06Q 50/04; G06N 3/092; G06Q 10/067; G06Q 10/0633

(57) ABSTRACT

The present invention relates to a factory simulator-based scheduling system using reinforcement learning, which schedules a process by training a neural network agent that determines a next action when a current state of a workflow is given in a factory environment in which a plurality of processes having a precedence relationship with each other constitutes a workflow and products are produced when the processes in the workflow are performed, and there is provided a factory simulator-based scheduling system using reinforcement learning, the system comprising a neural network agent having at least one neural network that outputs, when a state of a factory workflow (hereinafter, referred to as a workflow state) is input, a next work to be processed in the workflow state, wherein the neural network is trained by a reinforcement learning method; a factory simulator for simulating the factory workflow; and a reinforcement learning module for simulating the factory workflow using the factory simulator, extracting reinforcement learning data from a simulation result, and training the neural network of the neural network agent using the extracted reinforcement learning data. According to the system as described above, as learning data is configured by extracting a next state and a performance when an action of a specific process is performed in various process conditions through a simulator, there is an effect of stably training a neural network agent within a shorter time, and as a result, directing a more optimized work in the field.

### TECHNICAL FIELD

The present invention relates to a factory simulator-based scheduling system using reinforcement learning, which schedules a process by training a neural network agent that determines a next action when a current state of a workflow is given in a factory environment in which a plurality of processes having a precedence relationship with each other constitutes a workflow and products are produced when the processes in the workflow are performed.

Particularly, the present invention relates to a factory simulator-based scheduling system using reinforcement learning, which performs reinforcement learning on a neural network agent, when a given process state is input, to optimize a next action, such as inputting workpieces in a specific process or operating a facility, without using any history data generated in the factory in the past, and determines in real-time a next action of a corresponding process at an actual site using the trained neural network agent.

In addition, the present invention relates to a factory simulator-based scheduling system using reinforcement learning, which implements a workflow of processes using a factory simulator, generates learning data by simulating various cases using the simulator and collecting states, actions, and rewards of each process.

### BACKGROUND

Generally, manufacturing process management refers to an activity of managing a series of processes performed in a manufacturing process to process natural resources or materials until a product is completed. Particularly, it determines processes and work sequences required for manufacturing each product, and determines materials and time required in each process.

Particularly, in a factory that produces products, equipment for performing each work process is provided to be arranged in a work space of a corresponding process. It may be configured to supply parts for performing specific works in corresponding equipment. In addition, a transfer device such as a conveyor belt or the like is installed between the equipment or between the work spaces, and when a specific process is completed by the equipment, processed products or parts are moved to a next process.

In addition, a plurality of equipment having similar or identical functions may be installed to perform a specific process, and performs the same or similar work processes in a distributed manner.

Scheduling a process or each work in such a manufacturing line is a very important issue for efficiency of the factory. Conventionally, most of the scheduling has been performed in a rule-based way according to each condition, but evaluation on the performance of a generated scheduling result is ambiguous as the evaluation criteria are not clear.

In addition, a technique for scheduling works by adopting an artificial intelligence technique into a manufacturing process is proposed recently [Patent Document 1]. Although the prior art uses a machine learning algorithm called a genetic algorithm among artificial intelligence techniques, as it does not use a multi-layer neural network called a deep learning, and the work of a machine tool is limited to scheduling, it is difficult to apply the technique to the complicated manufacturing process of a factory configured of various works.

In addition, a technique that applies a neural network learning method to a process of multiple facilities is also proposed [Patent Document 2]. However, the prior art is a technique for finding an optimal control method in a given situation on the basis of past data, and there is a clear limitation in that it does not work without history data accumulated in the past. In addition, there is a problem in that much load is applied to the neural network as it needs to train all process variables related to the process and characteristics of past variables. In addition, there is a problem in that criteria for determining rewards and penalties on the basis of control results are provided by a manager (person).

### PRIOR ART LITERATURE

(Prior Art Document 1) Korean Patent Registration No. 10-1984460 (2019.05.30.)

(Prior Art Document 2) Korean Patent Registration No. 10-2035389 (2019.10.23.)

(Prior Art Document 3) V. Mnih et al., “Human-level control through deep reinforcement learning,” Nature, vol. 518, no. 7540, p. 529, 2015.

(Prior Art Document 4) The Goal: A Process of Ongoing Improvement, Eliyahu M. Goldratt 1984

### SUMMARY OF THE INVENTION

Therefore, the present invention has been made in view of the above problems, and it is an object of the present invention to provide a factory simulator-based scheduling system using reinforcement learning, which performs reinforcement learning on a neural network agent, when a given process state is input, to optimize decision-making about a next action, such as inputting workpieces in a specific process or operating a facility regardless of how the factory has been operated in the past, and determines in real-time a next action of a corresponding process at an actual site through the trained neural network agent.

In addition, another object of the present invention is to provide a factory simulator-based scheduling system using reinforcement learning, which learns by itself how to optimize a reward value set in advance when a next decision-making is carried out in the current state, without using any history, history data, examples, or the like about how the factory has been operated in the past.

In addition, another object of the present invention is to provide a factory simulator-based scheduling system using reinforcement learning, which implements a workflow of processes as a factory simulator, and generates learning data by simulating various cases using the simulator and collecting states, actions, and rewards of each process.

To accomplish the above objects, according to one aspect of the present invention, there is provided a factory simulator-based scheduling system using reinforcement learning, the system comprising: a neural network agent having at least one neural network that outputs, when a state of a factory workflow (hereinafter, referred to as a workflow state) is input, a next work to be processed in the workflow state, wherein the neural network is trained by a reinforcement learning method; a factory simulator for simulating the factory workflow; and a reinforcement learning module for simulating the factory workflow using the factory simulator, extracting reinforcement learning data from a simulation result, and training the neural network of the neural network agent using the extracted reinforcement learning data.

In addition, in the factory simulator-based scheduling system using reinforcement learning of the present invention, the factory workflow is configured of a plurality of processes, and each process is connected to another process in a precedence relationship to form a directional graph using a process as a node, wherein a neural network of the neural network agent is trained to output a next work of a process among a plurality of processes.

In addition, in the factory simulator-based scheduling system using reinforcement learning of the present invention, each process is configured of a plurality of works, and the neural network is configured to select an optimal one among a plurality of works of a corresponding process and output the work as a next work.

In addition, in the factory simulator-based scheduling system using reinforcement learning of the present invention, the neural network agent optimizes the neural network on the basis of the workflow state, a next work of a corresponding process performed in a corresponding state, a workflow state after a corresponding work is performed, and a reward obtained when a corresponding work is performed.

In addition, in the factory simulator-based scheduling system using reinforcement learning of the present invention, the factory simulator configures the factory workflow as a simulation model, and the simulation model of each process is modeled on the basis of a facility configuration and a processing capacity of a corresponding process.

In addition, in the factory simulator-based scheduling system using reinforcement learning of the present invention, the reinforcement learning module simulates a plurality of production episodes using the factory simulator to extract a workflow state and a work according to time order in each process, extract a reward in each state from the performance of a production episode, and collect reinforcement learning data using the extracted state, work, and reward.

In addition, in the factory simulator-based scheduling system using reinforcement learning of the present invention, the reinforcement learning module extract a transition configured of a next state Sₜ₊₁ and a reward rₜ from a current state Sₜ and work process a_{p,t} using the workflow state, the work, and the reward according to time order in each process, and generates the extracted transition as reinforcement learning data.

In addition, in the factory simulator-based scheduling system using reinforcement learning of the present invention, the reinforcement learning module randomly samples transitions from the reinforcement learning data and trains the neural network agent to learn using the sampled transitions.

As described above, in the factory simulator-based scheduling system using reinforcement learning according to the present invention, as learning data is configured by extracting a next state and a performance when an action of a specific process is performed in various process conditions through a simulator, there is an effect of stably training a neural network agent within a shorter time, and as a result, directing a more optimized work in the field.

In addition, in the factory simulator-based scheduling system using reinforcement learning according to the present invention, as a workflow state is configured by selecting only a state of a corresponding process or a related process when learning data is generated by a simulator, there is an effect of reducing the amount of input in a neural network, and training the neural network more accurately using a smaller amount of training data.

### BRIEF DESCRIPTION OF THE DRAWINGS

FIG. 1 is an exemplary view showing a model of a factory workflow according to an embodiment of the present invention.

FIG. 2 is a block diagram showing the configuration of a process according to an embodiment of the present invention.

FIG. 3 is a view showing an actual configuration of a process according to an embodiment of the present invention.

FIG. 4 is a table showing an example of a processing procedure corresponding to a work according to an embodiment of the present invention.

FIG. 5 is a table showing an example of the states of each process according to an embodiment of the present invention.

FIG. 6 is a view showing a basic operation structure of reinforcement learning used in the present invention.

FIG. 7 is a block diagram showing the configuration of a factory simulator-based scheduling system according to an embodiment of the present invention.

### DETAILED DESCRIPTION OF THE PREFERRED EMBODIMENT

Hereinafter, details for implementing the present invention will be described with reference to the drawings.

In addition, in describing the present invention, the same reference numerals are assigned to the same parts, and repeated explanation thereof will be omitted.

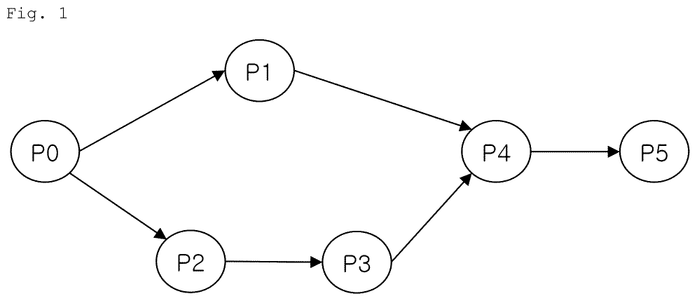

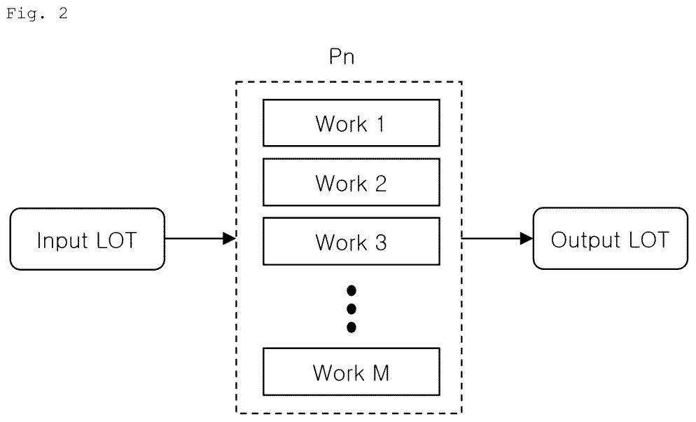

First, the configuration of a factory workflow model used in the present invention will be described with reference to FIGS. 1 and 2.

As shown in FIG. 1, a factory workflow is configured of a plurality of processes, and a process is connected to another process. In addition, the connected processes have a precedence relationship.

In the example shown in FIG. 1, the factory workflow is configured of processes P0, P1, P2, . . . , and P5, starting from process P0 and ending at process P5. When process P0 is completed, next processes P1 and P2 start. That is, corresponding processes can be processed only when a LOT processed in process P0 is provided to processes P1 and P2. Meanwhile, process P4 may perform a corresponding process only when completed LOTs are provided from processes P1 and P3.

In addition, the factory workflow does not produce only one product, but several products are processed and produced at the same time. Therefore, each process may be driven at the same time. For example, when a k-th product (or LOT) is produced in process P5, a k+1-th product may be intermediately-processed in process P4 at the same time.

Meanwhile, when a process is regarded as a node, the entire factory workflow forms a directional graph. Hereinafter, a process and a process node are interchangeably used for convenience of explanation.

In addition, a process may selectively perform a plurality of works. At this point, a LOT (hereinafter, an input LOT) is put into a corresponding process, and a processed LOT (hereinafter, an output LOT) is output (produced) as the work of the process is performed.

In the example shown in FIG. 2, process Pn is configured of work 1, work 2, . . . , work M. Process Pn selects and executes a work among M works. One of the works is selected and executed according to the environment at the moment or a request. The work at this point may be conceptually configured, not as an actual work in the field.

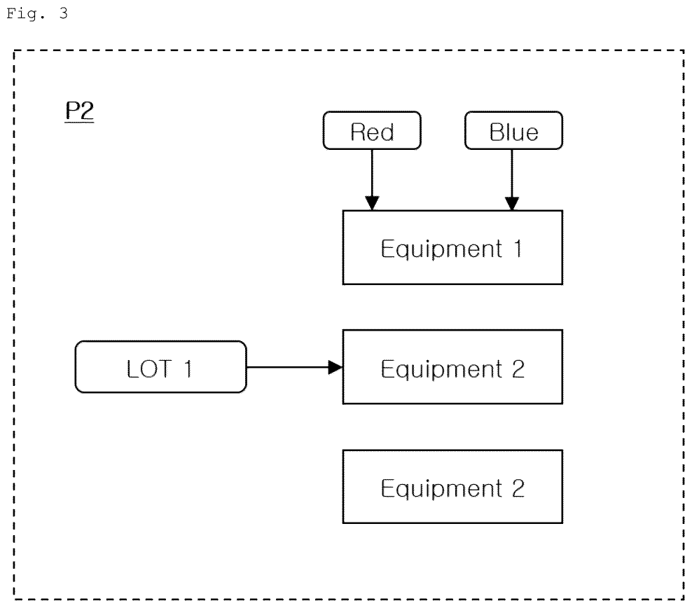

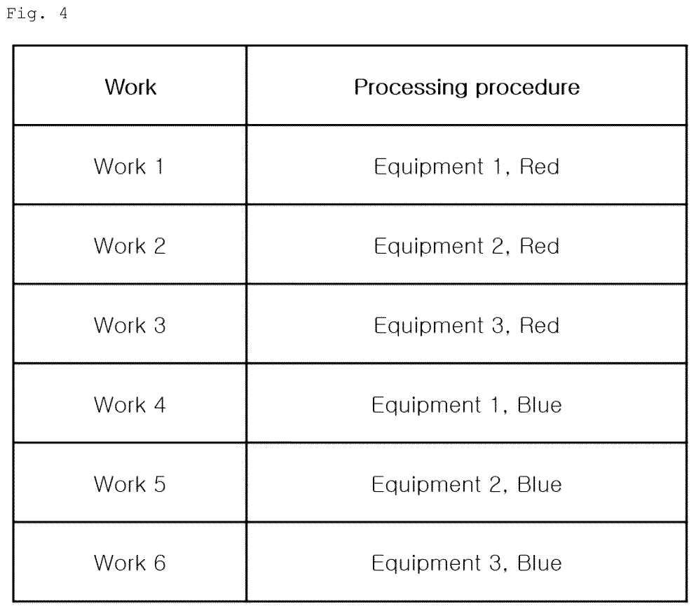

For example, process P2 at an actual site may be configured as shown in FIG. 3. That is, process P2 is a process of coloring a ballpoint pen. The coloring may be performed by selecting one of two colors, such as red or blue. In addition, three pieces of equipment are installed in the process, and the process can be performed using any one of the three pieces of equipment. Therefore, a total of 6 works may be configured by the combination of 2 types of colors and 3 types of equipment. Therefore, as shown in FIG. 4, a processing procedure corresponding to each work may be mapped.

In addition, as another example, equipment 1 and equipment 2 may be equipment capable of replacing supply of color during a process, but equipment 3 may be equipment fixed to only one color. In this case, the process will be configured of a total of five works.

Therefore, works in a process are configured of works that can be selectively performed in the field.

Meanwhile, an actual site in each process is set to the state of a corresponding process.

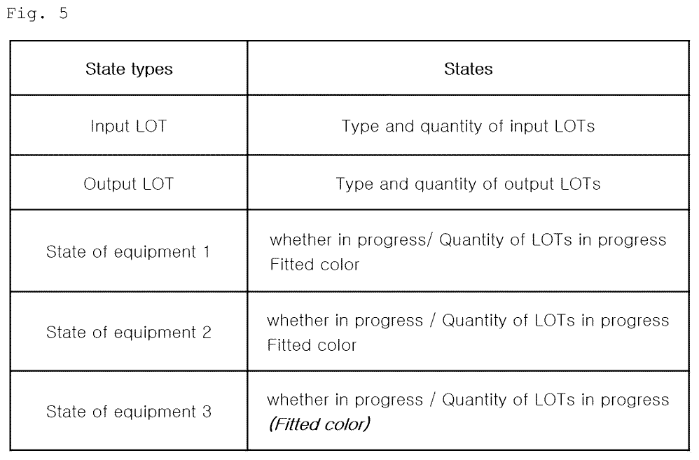

FIG. 5 shows the states of a process at the process site of FIG. 3. As shown in FIG. 5, a state of a process is configured of an input LOT, an output LOT, and a state of each process equipment. Preferably, the state is set for an element that changes during the procedure of the entire workflow. For example, when equipment 3 is fixedly set to one color in the entire workflow, it may not be set to a state. In addition, a time for changing color or a processing time of the equipment is not set as a state of the process. For reference, corresponding elements are set as simulation environment data of the simulator.

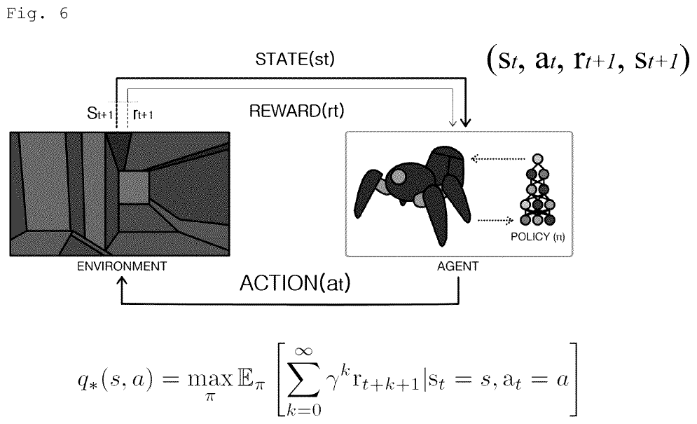

Next, reinforcement learning used in the present invention will be described with reference to FIG. 6. FIG. 6 shows the basic concept of the reinforcement learning.

As shown in FIG. 6, the artificial intelligence (AI) agent determines a specific action at when a current state Sₜ is given while communicating with the environment. Then, the determination is executed in the environment to change the state to Sₜ₊₁. According to the change of the state, the environment presents a predefined reward value rₜ to the artificial intelligence agent. Then, the artificial intelligence agent trains the neural network that presents the best action for the specific state so that the sum of future rewards may be maximized.

In the present invention, the environment is implemented by a factory simulator operating in a virtual environment.

In addition, the state, the action, and the reward, which are basic components of the reinforcement learning, are applied as follows. The state is configured of all of the process states, production goals, achievement status, and the like in the factory workflow. Preferably, the state is configured of the state of each process of the workflow and the state of the factory.

In addition, the action shows a work to be performed next in a specific process. That is, it is a next job selected after making a decision for preventing idleness of equipment when production of workpieces is finished in a corresponding process. That is, the action corresponds to a work (or work action) in a factory workflow model.

In addition, the reward is a main key performance index (KPI) used in factory management, such as the operation efficiency of production facilities (equipment) in a corresponding process or the entire workflow, a work turn-around time (TAT) of workpieces, a rate of achieving the production goal, and the like.

A factory simulator that simulates the behavior of the entire factory performs a function of an environment component of the reinforcement learning.

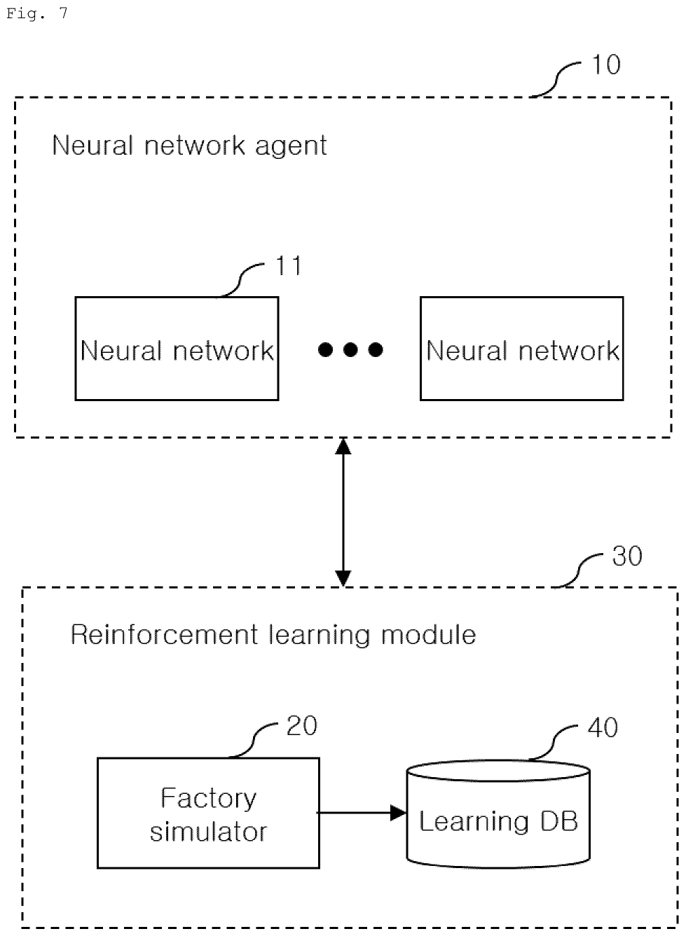

Next, the configuration of the factory simulator-based scheduling system using reinforcement learning according to an embodiment of the present invention will be described with reference to FIG. 7.

As shown in FIG. 7, the entire system for implementing the present invention includes a neural network agent 10 configured of neural networks 11, a factory simulator 20 for simulating the workflow of a factory, and a reinforcement learning module 30 for performing the reinforcement learning on the neural network agent 10. Additionally, it may be configured to further include a learning DB 40 for storing learning data for the reinforcement learning.

First, the neural network agent 10 is configured of at least one neural network 11 that outputs a next work (or work action) of a specific process when a factory state of a workflow is input.

Particularly, a neural network 11 is configured to determine a next work for a process. That is, preferably, one of a plurality of works that can be performed next is selected in a corresponding process. For example, the output of the neural network 11 is configured of nodes corresponding to all works, and the output of each node is a probability value, and a work corresponding to a node having the highest probability value is selected as the next work.

In addition, a plurality of neural networks 11 may be configured for each of a plurality of processes in order to determine a next work of the plurality of processes. In the example shown in FIG. 1, when there are 6 processes, a total of 6 neural networks 11 corresponding to each process may be configured. However, since a specific process does not need to be selected at any rate when there is only one work within a process, a neural network is not configured.

A neural network and optimization of the neural network use a general neural network method based on reinforcement learning, such as a Deep-Q Network (DQN) or the like. [Non-Patent Document 1]

In addition, the neural network agent 10 receives a workflow state Sₜ, a work at in a corresponding state, a workflow state Sₜ₊₁ after the process is performed by a corresponding work, and a reward rₜ for the work in the corresponding state, and optimizes parameters of the neural network 11 of the corresponding process.

In addition, when the neural network 11 is optimized (trained), the neural network agent 10 outputs a next work aₜ by applying the workflow state Sₜ to the optimized neural network 11.

Meanwhile, the workflow state Sₜ shows a workflow state at time t. Preferably, the workflow state is configured of a state of each process in the workflow and a factory state corresponding to the entire factory. In addition, preferably, the workflow state may include only the states of some processes in the workflow. At this point, the workflow state may include only the states of corresponding processes targeting only core processes, such as a process that induces a bottleneck in the workflow.

In addition, the workflow state is set targeting a component that changes in the process of the workflow. That is, a component that does not change even when the workflow is performed is not set as a state.

The state of each process (or process state) is configured of an input LOT, an output LOT, a state of each process equipment, and the like as shown in FIG. 5. In addition, the factory state shows a state in the entire process, such as a production target amount, an achieved state, and the like of a product.

Meanwhile, as described above, the state is set as the entire workflow state, and the action is set as a work in a corresponding process. That is, although the state includes both the arrangement state of LOTs and equipment states in the entire workflow, the action (or work) is limited to a specific process node. However, when a specific process node that becomes the largest bottleneck of the production capacity or requires decision-making is optimally scheduled in a factory, a theory of constraints (TOC) that does not care about the problems of associated preceding and succeeding process nodes is premised [Non-Patent Document 2]. This is like making an important decision at an important management point, such as a traffic light, a cross road, and an interchange, and for this purpose, traffic situations of all the connected roads should be reflected as a state.

Next, the factory simulator 20 is a general simulator that simulates factory workflows.

The factory workflow uses the workflow model as shown in FIG. 1. That is, the factory workflow model of a simulation is modeled as a directional graph configured of a plurality of nodes representing a process. However, each process model in a simulation is modeled as facility status at an actual site.

That is, as shown in FIG. 3, the process model is modeled using facility configurations and processing capacities, such as a LOT input into a corresponding process, a LOT output from a corresponding process, a plurality of equipment, materials or parts required for each equipment, a LOT input into each equipment or a LOT output from each equipment (type, quantity, and the like), processing speed of each equipment, time required for replacing a device in each equipment, and the like, as modeling variables.

The factory simulator described above employs a general simulation technique. Therefore, further detailed description will be omitted.

Next, the reinforcement learning module 30 performs a simulation using the factory simulator 20, extracts reinforcement learning data from a simulation result, and trains the neural network agent 10 using the extracted reinforcement learning data.

That is, the reinforcement learning module 30 simulates a plurality of production episodes using the factory simulator 20. The production episode means the entire process that produces a final product (or LOT). At this point, each production episode has a different processing procedure.

For example, performing a simulation for producing 100 red ballpoint pens and 50 blue ballpoint pens once is a production episode. At this point, detailed processes performed within a factory workflow may be different from each other. When a detailed process is simulated in a different way, another production episode is created. For example, a simulation using equipment 1 and a simulation using equipment 2 in process 2 in a specific state are production episodes different from each other.

When a production episode is simulated, a workflow state Sₜ and a work a_{p,t} may be extracted according to time order in each process. The workflow state Sₜ at time t is the same in any process since it is the state of the entire workflow. However, the work a_{p,t} in each process varies from process to process. Accordingly, a different work is extracted by the process p and time t.

In addition, the reinforcement learning module 30 sets in advance mapping information between a work in a neural network model and a modeling variable in the simulation model. Then, it determines to which work the processing procedure of the simulation model corresponds using the set mapping information. An example of the mapping information is shown in FIG. 4.

Meanwhile, the reward rₜ in each state Sₜ may be calculated in the reinforcement learning method. Preferably, the reward rₜ in each state Sₜ is calculated from the final result (or final performance) of a corresponding production episode. That is, the final result (or final performance) is calculated by a main key performance index (KPI) used in factory management, such as the operation efficiency of production facilities (equipment) in a corresponding process or the entire workflow, a work turn-around time (TAT) of workpieces, a rate of achieving the production goal, and the like.

In addition, transitions may be extracted when a state Sₜ, a work a_{p,t}, and a reward rₜ according to time order are extracted from production episodes. That is, the transition is configured of a next state Sₜ₊₁ and a reward rₜ from a current state Sₜ and a work a_{p,t}. This means that when a work a_{p,t} of a specific process is performed in the current state Sₜ, it is converted into the next state Sₜ₊₁, and a value of reward rₜ is obtained. Here, the reward r t means a value of the current state Sₜ when a work aₚ, is performed.

As described above, the reinforcement learning module 30 obtains production episodes by performing a simulation using the simulator 10, and constructs learning data by extracting transitions from the obtained episodes. At this point, a plurality of transitions may be extracted from one episode. Preferably, a plurality of episodes is generated through a simulation, and a large number of transitions are extracted from the episodes.

In addition, the reinforcement learning module 30 applies the extracted transitions to the neural network agent 10 to train the agent.

At this point, for example, transitions may be sequentially trained in time order. Preferably, the transitions are randomly sampled from the entire transition, and the neural network agent 10 is trained using the sampled transitions.

In addition, when the neural network agent 10 configures a plurality of neural networks, a corresponding neural network is trained using transition data of a process corresponding to each neural network.

Next, the learning DB 40 stores learning data for training the neural network agent 10. Preferably, the learning data is configured of a plurality of transitions.

Particularly, the transition data may be classified by the process.

As described above, when the reinforcement learning module 30 simulates a plurality of episodes using the simulator 20, a large amount of various transition data can be collected.

Although the present invention presented by the inventors has been described in detail according to an embodiment, the present invention is not limited to the embodiment, and various changes are possible without departing from the gist of the present invention.

It is informed that the present invention was accomplished through performing the following research support project.
[Project Serial Number] 1415169055
(Organization) [Detailed task Number] 20008651
[Government Department] Ministry of Trade, Industry and Energy
[Specialized Organization for Research Management] Korea Evaluation Institute of Industrial Technology
[Research Project Title] Knowledge service industry core technology development-manufacturing service convergence
[Research Task Title] Development of optimal decision-making and analysis tool application service based on reinforcement learning AI technology based on domain knowledge DB for small and medium-sized traditional manufacturing companies
[Contribution Rate] 1/1
[Host Organization] BI MATRIX Co., LTD.
[Performing Organization] NEUROCORE Co., Ltd.
[Research Period] 2020.05.01˜2022.12.31 (31 months)

1. A factory simulator-based scheduling system using reinforcement learning, the system comprising:
a neural network agent having at least one neural network that outputs, when a state of a factory workflow (hereinafter, referred to as a workflow state) is input, a next work to be processed in the workflow state, wherein the neural network is trained by a reinforcement learning method;
a factory simulator for simulating the factory workflow; and
a reinforcement learning module for simulating the factory workflow using the factory simulator, extracting reinforcement learning data from a simulation result, and training the neural network of the neural network agent using the extracted reinforcement learning data.

2. The system according to claim 1, wherein the factory workflow is configured of a plurality of processes, and each process is connected to another process in a precedence relationship to form a directional graph using a process as a node, wherein a neural network of the neural network agent is trained to output a next work of a process among a plurality of processes.

3. The system according to claim 2, wherein each process is configured of a plurality of works, and the neural network is configured to select an optimal one among a plurality of works of a corresponding process and output the work as a next work.

4. The system according to claim 2, wherein the neural network agent optimizes the neural network on the basis of the workflow state, a next work of a corresponding process performed in a corresponding state, a workflow state after a corresponding work is performed, and a reward obtained when a corresponding work is performed.

5. The system according to claim 4, wherein the workflow state includes a state of each process for all processes or some processes, and a state for the entire factory.

6. The system according to claim 3, wherein the factory simulator configures the factory workflow as a simulation model, and the simulation model of each process is modeled on the basis of a facility configuration and a processing capacity of a corresponding process.

7. The system according to claim 6, wherein the reinforcement learning module sets in advance mapping information between a work of each process and a modeling variable in the simulation model of each process, and determines to which work a processing procedure of the simulation model corresponds using the set mapping information.

8. The system according to claim 2, wherein the reinforcement learning module simulates a plurality of production episodes using the factory simulator to extract a workflow state and a work according to time order in each process, extract a reward in each state from the performance of a production episode, and collect reinforcement learning data using the extracted state, work, and reward.

9. The system according to claim 8, wherein the reinforcement learning module extract a transition configured of a next state Sₜ₊₁ and a reward rₜ from a current state Sₜ and work process a_{p,t} using the workflow state, the work, and the reward according to time order in each process, and generates the extracted transition as reinforcement learning data.

10. The system according to claim 9, wherein the reinforcement learning module randomly samples transitions from the reinforcement learning data and trains the neural network agent to learn using the sampled transitions.
